(19) United States
(12) Patent Application Publication
(10) Pub. No.: US 2012/0066273 A1
(43) Pub. Date: Mar. 15, 2012

(54) SYSTEM FOR AND METHODS OF AUTOMATICALLY INSERTING SYMBOLS INTO ELECTRONIC RECORDS OF LOCATE OPERATIONS

(75) Inventors: Steven Nielsen, North Palm Beach, FL (US); Curtis Chambers, Palm Beach Gardens, FL (US); Jeffrey Farr, Jupiter, FL (US)

(73) Assignee: CertusView Technologies, LLC

(21) Appl. No.: 13/185,194

(22) Filed: Jul. 18, 2011

Related U.S. Application Data
(60) Provisional application No. 61/369,090, filed on Jul. 30, 2010.

(51) Int. Cl. G06F 17/30

(52) U.S. Cl. 707/822; 707/E17.005

(57) ABSTRACT

Marking data representative of an underground facility locate operation is acquired by locate equipment and automatically processed so as to determine one or more symbols associated with the locate operation. A locate operation work order also may be processed with the marking data to determine the one or more symbols. An electronic record of the locate operation is generated and includes a graphic representation of the marking data as well as the one or more symbols.

### CROSS-REFERENCES TO RELATED APPLICATIONS

This application claims the benefit, under 35 U.S.C. §119(e), of U.S. Provisional Patent Application No. 61/369,090, filed on Jul. 30, 2010, under Atty. Docket No. 098689-0237 (DYC0071US00) entitled “System For and Methods of Automatically Inserting Symbols Into Electronic Records of Locate Operations,” which application is hereby incorporated herein by reference.

### BACKGROUND

Field service operations may be any operation in which companies dispatch technicians and/or other staff to perform certain activities, for example, installations, services and/or repairs. Field service operations may exist in various industries, examples of which include, but are not limited to, network installations, utility installations, security systems, construction, medical equipment, heating, ventilating and air conditioning (HVAC) and the like.

An example of a field service operation in the construction industry is a so-called “locate and marking operation,” also commonly referred to more simply as a “locate operation” (or sometimes merely as “a locate”). In a typical locate operation, a locate technician visits a work site in which there is a plan to disturb the ground (e.g., excavate, dig one or more holes and/or trenches, bore, etc.) so as to determine a presence or an absence of one or more underground facilities (such as various types of utility cables and pipes) in a dig area to be excavated or disturbed at the work site. In some instances, a locate operation may be requested for a “design” project, in which there may be no immediate plan to excavate or otherwise disturb the ground, but nonetheless information about a presence or absence of one or more underground facilities at a work site may be valuable to inform a planning, permitting and/or engineering design phase of a future construction project.

In many states, an excavator who plans to disturb ground at a work site is required by law to notify any potentially affected underground facility owners prior to undertaking an excavation activity. Advanced notice of excavation activities may be provided by an excavator (or another party) by contacting a “one-call center.” One-call centers typically are operated by a consortium of underground facility owners for the purposes of receiving excavation notices and in turn notifying facility owners and/or their agents of a plan to excavate. As part of an advanced notification, excavators typically provide to the one-call center various information relating to the planned activity, including a location (e.g., address) of the work site and a description of the dig area to be excavated or otherwise disturbed at the work site.

A locate operation is initiated as a result of an excavator providing an excavation notice to a one-call center. An excavation notice also is commonly referred to as a “locate request,” and may be provided by the excavator to the one-call center via an electronic mail message, information entry via a website maintained by the one-call center, or a telephone conversation between the excavator and a human operator at the one-call center. The locate request may include an address or some other location-related information describing the geographic location of a work site at which the excavation is to be performed, as well as a description of the dig area (e.g., a text description), such as its location relative to certain landmarks and/or its approximate dimensions, within which there is a plan to disturb the ground at the work site. One-call centers similarly may receive locate requests for design projects (for which, as discussed above, there may be no immediate plan to excavate or otherwise disturb the ground).

Once facilities implicated by the locate request are identified by a one-call center, the one-call center generates a “locate request ticket” (also known as a “locate ticket,” or simply a “ticket”). The locate request ticket essentially constitutes an instruction to inspect a work site and typically identifies the work site of the proposed excavation or design and a description of the dig area, typically lists on the ticket all of the underground facilities that may be present at the work site (e.g., by providing a member code for the facility owner of an underground facility), and may also include various other information relevant to the proposed excavation or design (e.g., the name of the excavation company, a name of a property owner or party contracting the excavation company to perform the excavation, etc.). The one-call center sends the ticket to one or more underground facility owners and/or one or more locate service providers (who may be acting as contracted agents of the facility owners) so that they can conduct a locate and marking operation to verify a presence or absence of the underground facilities in the dig area. For example, in some instances, a given underground facility owner may operate its own fleet of locate technicians, in which case the one-call center may send the ticket to the underground facility owner. In other instances, a given facility owner may contract with a locate service provider to receive locate request tickets and perform a locate and marking operation in response to received tickets on their behalf.

Upon receiving the locate request, a locate service provider or a facility owner (hereafter referred to as a “ticket recipient”) may dispatch a locate technician to the work site of planned excavation to determine a presence or absence of one or more underground facilities in the dig area to be excavated or otherwise disturbed. A typical first step for the locate technician includes utilizing an underground facility “locate device,” which is an instrument or set of instruments (also referred to commonly as a “locate set”) for detecting facilities that are concealed in some manner, such as cables and pipes that are located underground. The locate device is employed by the technician to verify the presence or absence of underground facilities indicated in the locate request ticket as potentially present in the dig area (e.g., via the facility owner member codes listed in the ticket). This process is often referred to as a “locate operation.”

In one example of a locate operation, an underground facility locate device is used to detect electromagnetic fields that are generated by an applied signal provided along a length of a target facility to be identified. In this example, a locate device may include both a signal transmitter to provide the applied signal (e.g., which is coupled by the locate technician to a tracer wire disposed along a length of a facility), and a signal receiver which is generally a hand-held apparatus carried by the locate technician as the technician walks around the dig area to search for underground facilities. The transmitter is connected, via a connection point, to a target object located in the ground. The transmitter generates the applied signal, which is coupled to the underground facility via the connection point (e.g., to a tracer wire along the facility), resulting in the generation of a magnetic field. The magnetic field in turn is detected by the locate receiver, which itself may include at least one detection antenna. The locate receiver indicates a presence of a facility when it detects electromagnetic fields arising from the applied signal. Conversely, the absence of a signal detected by the locate receiver generally indicates the absence of the target facility.

In yet another example, a locate device employed for a locate operation may include a single instrument, similar in some respects to a conventional metal detector. In particular, such an instrument may include an oscillator to generate an alternating current that passes through a coil, which in turn produces a first magnetic field. If a piece of electrically conductive metal is in close proximity to the coil (e.g., if an underground facility having a metal component is below/near the coil of the instrument), eddy currents are induced in the metal and the metal produces its own magnetic field, which in turn affects the first magnetic field. The instrument may include a second coil to measure changes to the first magnetic field, thereby facilitating detection of metallic objects.

In addition to the locate operation, the locate technician also generally performs a “marking operation,” in which the technician marks the presence (and in some cases the absence) of a given underground facility in the dig area based on the various signals detected (or not detected) during the locate operation. For this purpose, the locate technician conventionally utilizes a “marking device” to dispense a marking material on, for example, the ground, pavement, or other surface along a detected underground facility. Marking material may be any material, substance, compound, and/or element, used or which may be used separately or in combination to mark, signify, and/or indicate. Examples of marking materials may include, but are not limited to, paint, chalk, dye, and/or iron. Marking devices, such as paint marking wands and/or paint marking wheels, provide a convenient method of dispensing marking materials onto surfaces, such as onto the surface of the ground or pavement.

A conventional marking device includes a mechanical actuation system to dispense paint as a marker. Generally speaking, the marking device includes a handle at a proximal end of an elongated shaft and resembles a sort of “walking stick,” such that a technician may operate the marking device while standing/walking in an upright or substantially upright position. A marking dispenser holder is coupled to a distal end of the shaft so as to contain and support a marking dispenser, e.g., an aerosol paint can having a spray nozzle. Typically, a marking dispenser in the form of an aerosol paint can is placed into the holder upside down, such that the spray nozzle is proximate to the distal end of the shaft (close to the ground, pavement or other surface on which markers are to be dispensed).

The mechanical actuation system of the marking device includes an actuator or mechanical trigger proximate to the handle that is actuated/triggered by the technician (e.g., via pulling, depressing or squeezing with fingers/hand). The actuator is connected to a mechanical coupler (e.g., a rod) disposed inside and along a length of the elongated shaft. The coupler is in turn connected to an actuation mechanism, at the distal end of the shaft, which mechanism extends outward from the shaft in the direction of the spray nozzle. Thus, the actuator, the mechanical coupler, and the actuation mechanism 58 constitute the mechanical actuation system of the marking device.

In the non-actuated state of the conventional marking device, the actuator is “at rest” (not being pulled) and, as a result, the actuation mechanism is not in contact with the spray nozzle. In the actuated state, the actuator is being actuated (pulled, depressed, squeezed) by the technician. When actuated, the actuator displaces the mechanical coupler and the actuation mechanism such that the actuation mechanism contacts and applies pressure to the spray nozzle, thus causing the spray nozzle to deflect slightly and dispense paint. The mechanical actuation system is spring-loaded so that it automatically returns to the non-actuated state when the actuator is released.

In some environments, arrows, flags, darts, or other types of physical marks may be used to mark the presence or absence of an underground facility in a dig area, in addition to or as an alternative to a material applied to the ground (such as paint, chalk, dye, tape) along the path of a detected utility. The marks resulting from any of a wide variety of materials and/or objects used to indicate a presence or absence of underground facilities generally are referred to as “locate marks.” Often, different color materials and/or physical objects may be used for locate marks, wherein different colors correspond to different utility types. For example, the American Public Works Association (APWA) has established a standardized color-coding system for utility identification for use by public agencies, utilities, contractors and various groups involved in ground excavation (e.g., red=electric power lines and cables; blue=potable water; orange=telecommunication lines; yellow=gas, oil, steam). In some cases, the technician also may provide one or more marks to indicate that no facility was found in the dig area (sometimes referred to as a “clear”).

As mentioned above, the foregoing activity of identifying and marking a presence or absence of one or more underground facilities generally is referred to for completeness as a “locate and marking operation.” However, in light of common parlance adopted in the construction industry, and/or for the sake of brevity, one or both of the respective locate and marking functions may be referred to in some instances simply as a “locate operation” or a “locate” (i.e., without making any specific reference to the marking function). Accordingly, it should be appreciated that any reference in the relevant arts to the task of a locate technician simply as a “locate operation” or a “locate” does not necessarily exclude the marking portion of the overall process. At the same time, in some contexts a locate operation is identified separately from a marking operation, wherein the former relates more specifically to detection-related activities and the latter relates more specifically to marking-related activities.

Inaccurate locating and/or marking of underground facilities can result in physical damage to the facilities, property damage, and/or personal injury during the excavation process that, in turn, can expose a facility owner or contractor to significant legal liability. When underground facilities are damaged and/or when property damage or personal injury results from damaging an underground facility during an excavation, the excavator may assert that the facility was not accurately located and/or marked by a locate technician, while the locate contractor who dispatched the technician may in turn assert that the facility was indeed properly located and marked. Proving whether the underground facility was properly located and marked can be difficult after the excavation (or after some damage, e.g., a gas explosion), because in many cases the physical locate marks (e.g., the marking material or other physical marks used to mark the facility on the surface of the dig area) will have been disturbed or destroyed during the excavation process (and/or damage resulting from excavation).

### SUMMARY

Applicants have recognized and appreciated that uncertainties which may be attendant to locate and marking operations may be significantly reduced by collecting various information particularly relating to the marking operation, and in some cases both the marking operation and the corresponding locate operation, rather than merely focusing on information relating to detection of underground facilities via a locate device. In many instances, excavators arriving to a work site have only physical locate marks on which to rely to indicate a presence or absence of underground facilities, and they are not generally privy to information that may have been collected previously during the locate operation. Accordingly, the integrity and accuracy of the physical locate marks applied during a marking operation arguably is significantly more important in connection with reducing risk of damage and/or injury during excavation than the location where an underground facility was detected via a locate device during a locate operation.

More specifically, Applicants have recognized and appreciated that conventional techniques for using a locate device to detect underground facilities are sometimes tentative and typically iterative in nature, and use of locate devices with GPS capabilities may result in redundant, spurious and/or incomplete geographic location data collection. For example, during a typical locate operation, a technician attempting to locate an underground facility with a locate device often needs to sweep an appreciable area around a suspected underground facility, and make multiple passes with the locate device over the underground facility to obtain meaningful detection signals. Furthermore, the technician often needs to rely significantly on visual observations of the area, including relevant landmarks such as facility connections to buildings, transformer boxes, maintenance/public access points, curbs, sidewalks, roadways, etc., to effectively deduce a sensible path of an underground facility to be located. The foregoing is particularly true if at some point during the locate operation the technician loses a signal from an underground facility in the process of being detected (e.g., due to a broken transmitter circuit path from a damaged tracer wire, and loss of the transmitter's applied signal). In view of the foregoing, it may be readily appreciated that collecting and logging geographic location information throughout this process may result in excessive and/or imprecise data, or in some instances incomplete relevant data (e.g., in the case of signal loss/broken tracer wire), from which it may be difficult to cull the data that is truly complete and representative of where the underground facility ultimately was detected.

Yet, Applicants have recognized and appreciated that collecting location data, such as GPS data, in connection with use of a locate device may be valuable for reasons other than marking a location of an underground facility. For example, the data may be valuable in monitoring the performance of a technician (e.g., by comparing performance to a known “signature” of a technician's historical performance), mapping areas of poor signal strength, or for other reasons. The data may be processed in various manners of use to various parties, depending on their particular interest in a locate operation. In addition, as described further below, the collection of GPS data with respect to both locate and marking operations, as opposed to locate operations alone, may also provide valuable insight and analysis potential with respect to various aspects (e.g., technician performance, comparison to historical data, etc.) of a locate operation.

Furthermore, Applicants have recognized and appreciated that the location at which an underground facility ultimately is detected during a locate operation is not always where the technician physically marks the ground, pavement or other surface during a marking operation; in fact, technician imprecision or negligence, as well as various ground conditions and/or different operating conditions amongst different locate devices, may in some instances result in significant discrepancies between detected location and physical locate marks. Accordingly, having documentation (e.g., an electronic record) of where physical locate marks were actually dispensed (i.e., what an excavator encounters when arriving to a work site) is notably more relevant to the assessment of liability in the event of damage and/or injury than where an underground facility was detected prior to marking.

Examples of marking devices configured to collect some types of information relating specifically to marking operations are provided in U.S. publication no. 2008-0228294-A1, published Sep. 18, 2008, filed Mar. 13, 2007, and entitled “Marking System and Method With Location and/or Time Tracking,” and U.S. publication no. 2008-0245299-A1, published Oct. 9, 2008, filed Apr. 4, 2007, and entitled “Marking System and Method,” both of which publications are incorporated herein by reference. These publications describe, amongst other things, collecting information relating to the geographic location, time, and/or characteristics (e.g., color/type) of dispensed marking material from a marking device and generating an electronic record based on this collected information. Applicants have recognized and appreciated that collecting information relating to both geographic location and color of dispensed marking material provides for automated correlation of geographic information for a locate mark to facility type (e.g., red=electric power lines and cables; blue=potable water; orange=telecommunication lines; yellow=gas, oil, steam).

In view of the foregoing, embodiments of the invention relate to a locate operations system for and methods of automatically inserting symbols into electronic records of locate operations. The locate operations system includes a geo-enabled electronic marking device or any other piece of locate equipment that is capable of acquiring digital information about the marking operation (hereafter called marking data). For purposes of the present disclosure, “locate equipment” refers to any device or apparatus used by a technician in connection with performance of a locate and/or marking operation (e.g., a locate device such as a transmitter and/or receiver, a marking device, a combined locate and marking device, etc.).

Each sample of data in the marking data is timestamped and geo-referenced. By use of the marking data, electronic records of locate operations may be generated. Inserting symbols and/or other information relating to symbols (referred to generally as “symbols information” or “symbols data”) into the electronic records of locate operations allows, for example, the symbols to be rendered in corresponding graphical representations of locate operations. The symbols information may be distinguished from other data in the electronic data of locate operations. For example, the symbols information may be rendered as a separate layer in any graphical representations of locate operations.

Symbols may be any marks that communicate information other than a lines pattern for indicating the location of facilities. Examples of symbols may include, but are not limited to, alphanumeric characters (e.g., letters and numbers) and geometric symbols (e.g., circles, squares, rectangles, diamonds, lines, etc). In one example, a symbol indicates the owner of the facility being marked. For example, a gas facility owned by Washington Gas, which is a subsidiary of WGL Holdings, Inc. (Washington, D.C.), may be labeled with the symbol “WGL.” In this example, “WGL” may be inserted into the electronic record periodically along the lines pattern that indicates the location of the gas facility. In another example, a diamond symbol indicates that a group of facilities are running together in a conduit or in a common trench. In this example, the diamond symbol may be inserted into the electronic record periodically along the lines patterns that indicate the location of this group of facilities.

In one embodiment of the present invention, a software application that may operate separately from the marking device (1) reads the locate operation work order information, (2) reads the associated raw marking data (e.g., obtained from the marking device), (3) processes both the locate operation work order information and the raw marking data, (4) determines the symbols to be inserted into the electronic record of the locate operation, (5) processes the electronic record that has symbols automatically inserted therein by, for example, rendering a graphical representation of the locate operation, and (6) saves the graphical representation of the locate operation rendered from the electronic record that has symbols automatically inserted therein. In this example, substantially all data processing to automatically insert the symbols is performed by the software application that is receiving the locate operation work order information and raw marking data. That is, the data processing capability for automatically inserting the symbols is provided separately from the marking device, such that no special data processing capability is required at the marking device.

In another embodiment of the present invention, a software application on the marking device (1) reads the locate operation work order information, (2) reads the associated raw marking data, (3) processes both the locate operation work order information and the raw marking data, (4) determines the symbols data to be inserted into the raw marking data that will be used to generate the electronic record of locate operations, (5) automatically modifies the raw marking data to include the symbols data, and (6) saves the modified marking data. In this embodiment, a separate software application, such as an image viewer application, may read the modified marking data that includes the symbols data. The software application may then present the modified marking data by rendering a graphical representation of the locate operations, which includes automatically rendering the symbols data in the modified marking data. In this example, substantially all data processing to automatically insert the symbols data is performed by a software application on the marking device. That is, the data processing capability for automatically inserting the symbols resides at the marking device, such that no special data processing capability is required at the viewer application that receives and renders the modified marking data.

According to a first aspect of the invention, a method is provided for logging an electronic record of a locate operation to locate the presence or absence of underground facilities. The method comprises acquiring, by locate equipment, marking data representative of the locate operation; automatically determining at least one symbol associated with the locate operation, the symbol represented by symbol data; and storing the marking data and the associated symbol data to form an electronic record of the locate operation.

According to a second aspect of the invention, a system is provided for logging an electronic record of a locate operation to locate the presence or absence of underground facilities. The system comprises locate equipment configured to perform at least part of the locate operation and to acquire marking data representative of the locate operation; and a computing device distinct from the locate equipment, the computing device configured to receive the marking data from the locate equipment, to automatically determine at least one symbol associated with the locate operation, the symbol represented by symbol data, and to store the marking data and symbol data to form an electronic record of the locate operation, the symbol data, representative of at least one symbol, being automatically determined by the locate equipment or the computing device.

According to a third aspect of the invention, locate equipment is provided for performing a locate operation to locate the presence or absence of underground facilities. The locate equipment comprises a marking material dispensing system configured to dispense marking material during the locate operation; a data acquisition module configured to acquire marking data representative of the locate operation; a symbol insertion module configured to automatically determine at least one symbol associated with the locate operation, the symbol represented by symbol data; and a memory configured to store the marking data and the associated symbol data to form an electronic record of the locate operation.

For purposes of the present disclosure, the term “dig area” refers to a specified area of a work site within which there is a plan to disturb the ground (e.g., excavate, dig holes and/or trenches, bore, etc.), and beyond which there is no plan to excavate in the immediate surroundings. Thus, the metes and bounds of a dig area are intended to provide specificity as to where some disturbance to the ground is planned at a given work site. It should be appreciated that a given work site may include multiple dig areas.

The term “facility” refers to one or more lines, cables, fibers, conduits, transmitters, receivers, or other physical objects or structures capable of or used for carrying, transmitting, receiving, storing, and providing utilities, energy, data, substances, and/or services, and/or any combination thereof. The term “underground facility” means any facility beneath the surface of the ground. Examples of facilities include, but are not limited to, oil, gas, water, sewer, power, telephone, data transmission, cable television (TV), and/or internet services.

The term “locate device” refers to any apparatus and/or device for detecting and/or inferring the presence or absence of any facility, including without limitation, any underground facility. In various examples, a locate device may include both a locate transmitter and a locate receiver (which in some instances may also be referred to collectively as a “locate instrument set,” or simply “locate set”).

The term “marking device” refers to any apparatus, mechanism, or other device that employs a marking dispenser for causing a marking material and/or marking object to be dispensed, or any apparatus, mechanism, or other device for electronically indicating (e.g., logging in memory) a location, such as a location of an underground facility. Additionally, the term “marking dispenser” refers to any apparatus, mechanism, or other device for dispensing and/or otherwise using, separately or in combination, a marking material and/or a marking object. An example of a marking dispenser may include, but is not limited to, a pressurized can of marking paint. The term “marking material” means any material, substance, compound, and/or element, used or which may be used separately or in combination to mark, signify, and/or indicate. Examples of marking materials may include, but are not limited to, paint, chalk, dye, and/or iron. The term “marking object” means any object and/or objects used or which may be used separately or in combination to mark, signify, and/or indicate. Examples of marking objects may include, but are not limited to, a flag, a dart, and arrow, and/or an RFID marking ball. It is contemplated that marking material may include marking objects. It is further contemplated that the terms “marking materials” or “marking objects” may be used interchangeably in accordance with the present disclosure.

The term “locate mark” means any mark, sign, and/or object employed to indicate the presence or absence of any underground facility. Examples of locate marks may include, but are not limited to, marks made with marking materials, marking objects, global positioning or other information, and/or any other means. Locate marks may be represented in any form including, without limitation, physical, visible, electronic, and/or any combination thereof.

The terms “actuate” or “trigger” (verb form) are used interchangeably to refer to starting or causing any device, program, system, and/or any combination thereof to work, operate, and/or function in response to some type of signal or stimulus. Examples of actuation signals or stimuli may include, but are not limited to, any local or remote, physical, audible, inaudible, visual, non-visual, electronic, mechanical, electromechanical, biomechanical, biosensing or other signal, instruction, or event. The terms “actuator” or “trigger” (noun form) are used interchangeably to refer to any method or device used to generate one or more signals or stimuli to cause or causing actuation. Examples of an actuator/trigger may include, but are not limited to, any form or combination of a lever, switch, program, processor, screen, microphone for capturing audible commands, and/or other device or method. An actuator/trigger may also include, but is not limited to, a device, software, or program that responds to any movement and/or condition of a user, such as, but not limited to, eye movement, brain activity, heart rate, other data, and/or the like, and generates one or more signals or stimuli in response thereto. In the case of a marking device or other marking mechanism (e.g., to physically or electronically mark a facility or other feature), actuation may cause marking material to be dispensed, as well as various data relating to the marking operation (e.g., geographic location, time stamps, characteristics of material dispensed, etc.) to be logged in an electronic file stored in memory. In the case of a locate device or other locate mechanism (e.g., to physically locate a facility or other feature), actuation may cause a detected signal strength, signal frequency, depth, or other information relating to the locate operation to be logged in an electronic file stored in memory.

The terms “locate and marking operation,” “locate operation,” and “locate” generally are used interchangeably and refer to any activity to detect, infer, and/or mark the presence or absence of an underground facility. In some contexts, the term “locate operation” is used to more specifically refer to detection of one or more underground facilities, and the term “marking operation” is used to more specifically refer to using a marking material and/or one or more marking objects to mark a presence or an absence of one or more underground facilities. The term “locate technician” refers to an individual performing a locate operation. A locate and marking operation often is specified in connection with a dig area, at least a portion of which may be excavated or otherwise disturbed during excavation activities.

The term “user” refers to an individual utilizing a locate device and/or a marking device and may include, but is not limited to, land surveyors, locate technicians, and support personnel.

The terms “locate request” and “excavation notice” are used interchangeably to refer to any communication to request a locate and marking operation. The term “locate request ticket” (or simply “ticket”) refers to any communication or instruction to perform a locate operation. A ticket might specify, for example, the address or description of a dig area to be marked, the day and/or time that the dig area is to be marked, and/or whether the user is to mark the excavation area for certain gas, water, sewer, power, telephone, cable television, and/or some other underground facility. The term “historical ticket” refers to past tickets that have been completed.

The following U.S. published applications are hereby incorporated herein by reference:
U.S. Pat. No. 7,640,105, issued Dec. 29, 2009, filed Mar. 13, 2007, and entitled “Marking System and Method With Location and/or Time Tracking;”
U.S. publication no. 2010-0094553-A1, published Apr. 15, 2010, filed Dec. 16, 2009, and entitled “Systems and Methods for Using Location Data and/or Time Data to Electronically Display Dispensing of Markers by A Marking System or Marking Tool;”
U.S. publication no. 2008-0245299-A1, published Oct. 9, 2008, filed Apr. 4, 2007, and entitled “Marking System and Method;”
U.S. publication no. 2009-0013928-A1, published Jan. 15, 2009, filed Sep. 24, 2008, and entitled “Marking System and Method;”
U.S. publication no. 2010-0090858-A1, published Apr. 15, 2010, filed Dec. 16, 2009, and entitled “Systems and Methods for Using Marking Information to Electronically Display Dispensing of Markers by a Marking System or Marking Tool;”
U.S. publication no. 2009-0238414-A1, published Sep. 24, 2009, filed Mar. 18, 2008, and entitled “Virtual White Lines for Delimiting Planned Excavation Sites;”
U.S. publication no. 2009-0241045-A1, published Sep. 24, 2009, filed Sep. 26, 2008, and entitled “Virtual White Lines for Delimiting Planned Excavation Sites;”
U.S. publication no. 2009-0238415-A1, published Sep. 24, 2009, filed Sep. 26, 2008, and entitled “Virtual White Lines for Delimiting Planned Excavation Sites;”
U.S. publication no. 2009-0241046-A1, published Sep. 24, 2009, filed Jan. 16, 2009, and entitled “Virtual White Lines for Delimiting Planned Excavation Sites;”
U.S. publication no. 2009-0238416-A1, published Sep. 24, 2009, filed Jan. 16, 2009, and entitled “Virtual White Lines for Delimiting Planned Excavation Sites;”
U.S. publication no. 2009-0237408-A1, published Sep. 24, 2009, filed Jan. 16, 2009, and entitled “Virtual White Lines for Delimiting Planned Excavation Sites;”
U.S. publication no. 2011-0135163-A1, published Jun. 9, 2011, filed Feb. 16, 2011, and entitled “Methods and Apparatus for Providing Unbuffered Dig Area Indicators on Aerial Images to Delimit Planned Excavation Sites;”
U.S. publication no. 2009-0202101-A1, published Aug. 13, 2009, filed Feb. 12, 2008, and entitled “Electronic Manifest of Underground Facility Locate Marks;”
U.S. publication no. 2009-0202110-A1, published Aug. 13, 2009, filed Sep. 11, 2008, and entitled “Electronic Manifest of Underground Facility Locate Marks;”
U.S. publication no. 2009-0201311-A1, published Aug. 13, 2009, filed Jan. 30, 2009, and entitled “Electronic Manifest of Underground Facility Locate Marks;”
U.S. publication no. 2009-0202111-A1, published Aug. 13, 2009, filed Jan. 30, 2009, and entitled “Electronic Manifest of Underground Facility Locate Marks;”
U.S. publication no. 2009-0204625-A1, published Aug. 13, 2009, filed Feb. 5, 2009, and entitled “Electronic Manifest of Underground Facility Locate Operation;”
U.S. publication no. 2009-0204466-A1, published Aug. 13, 2009, filed Sep. 4, 2008, and entitled “Ticket Approval System For and Method of Performing Quality Control In Field Service Applications;”
U.S. publication no. 2009-0207019-A1, published Aug. 20, 2009, filed Apr. 30, 2009, and entitled “Ticket Approval System For and Method of Performing Quality Control In Field Service Applications;”
U.S. publication no. 2009-0210284-A1, published Aug. 20, 2009, filed Apr. 30, 2009, and entitled “Ticket Approval System For and Method of Performing Quality Control In Field Service Applications;”
U.S. publication no. 2009-0210297-A1, published Aug. 20, 2009, filed Apr. 30, 2009, and entitled “Ticket Approval System For and Method of Performing Quality Control In Field Service Applications;”
U.S. publication no. 2009-0210298-A1, published Aug. 20, 2009, filed Apr. 30, 2009, and entitled “Ticket Approval System For and Method of Performing Quality Control In Field Service Applications;”
U.S. publication no. 2009-0210285-A1, published Aug. 20, 2009, filed Apr. 30, 2009, and entitled “Ticket Approval System For and Method of Performing Quality Control In Field Service Applications;”
U.S. publication no. 2009-0324815-A1, published Dec. 31, 2009, filed Apr. 24, 2009, and entitled “Marking Apparatus and Marking Methods Using Marking Dispenser with Machine-Readable ID Mechanism;”
U.S. publication no. 2010-0006667-A1, published Jan. 14, 2010, filed Apr. 24, 2009, and entitled, “Marker Detection Mechanisms for use in Marking Devices And Methods of Using Same;”
U.S. publication no. 2010-0085694 A1, published Apr. 8, 2010, filed Sep. 30, 2009, and entitled, “Marking Device Docking Stations and Methods of Using Same;”
U.S. publication no. 2010-0085701 A1, published Apr. 8, 2010, filed Sep. 30, 2009, and entitled, “Marking Device Docking Stations Having Security Features and Methods of Using Same;”
U.S. publication no. 2010-0084532 A1, published Apr. 8, 2010, filed Sep. 30, 2009, and entitled, “Marking Device Docking Stations Having Mechanical Docking and Methods of Using Same;”
U.S. publication no. 2010-0088032-A1, published Apr. 8, 2010, filed Sep. 29, 2009, and entitled, “Methods, Apparatus and Systems for Generating Electronic Records of Locate And Marking Operations, and Combined Locate and Marking Apparatus for Same;”
U.S. publication no. 2010-0117654 A1, published May 13, 2010, filed Dec. 30, 2009, and entitled, “Methods and Apparatus for Displaying an Electronic Rendering of a Locate and/or Marking Operation Using Display Layers;”
U.S. publication no. 2010-0086677 A1, published Apr. 8, 2010, filed Aug. 11, 2009, and entitled, “Methods and Apparatus for Generating an Electronic Record of a Marking Operation Including Service-Related Information and Ticket Information;”
U.S. publication no. 2010-0086671 A1, published Apr. 8, 2010, filed Nov. 20, 2009, and entitled, “Methods and Apparatus for Generating an Electronic Record of A Marking Operation Including Service-Related Information and Ticket Information;”
U.S. publication no. 2010-0085376 A1, published Apr. 8, 2010, filed Oct. 28, 2009, and entitled, “Methods and Apparatus for Displaying an Electronic Rendering of a Marking Operation Based on an Electronic Record of Marking Information;”
U.S. publication no. 2010-0088164-A1, published Apr. 8, 2010, filed Sep. 30, 2009, and entitled, “Methods and Apparatus for Analyzing Locate and Marking Operations with Respect to Facilities Maps;”
U.S. publication no. 2010-0088134 A1, published Apr. 8, 2010, filed Oct. 1, 2009, and entitled, “Methods and Apparatus for Analyzing Locate and Marking Operations with Respect to Historical Information;”
U.S. publication no. 2010-0088031 A1, published Apr. 8, 2010, filed Sep. 28, 2009, and entitled, “Methods and Apparatus for Generating an Electronic Record of Environmental Landmarks Based on Marking Device Actuations;”
U.S. publication no. 2010-0188407 A1, published Jul. 29, 2010, filed Feb. 5, 2010, and entitled “Methods and Apparatus for Displaying and Processing Facilities Map Information and/or Other Image Information on a Marking Device;”
U.S. publication no. 2010-0198663 A1, published Aug. 5, 2010, filed Feb. 5, 2010, and entitled “Methods and Apparatus for Overlaying Electronic Marking Information on Facilities Map Information and/or Other Image Information Displayed on a Marking Device;”
U.S. publication no. 2010-0188215 A1, published Jul. 29, 2010, filed Feb. 5, 2010, and entitled “Methods and Apparatus for Generating Alerts on a Marking Device, Based on Comparing Electronic Marking Information to Facilities Map Information and/or Other Image Information;”
U.S. publication no. 2010-0188088 A1, published Jul. 29, 2010, filed Feb. 5, 2010, and entitled “Methods and Apparatus for Displaying and Processing Facilities Map Information and/or Other Image Information on a Locate Device;”
U.S. publication no. 2010-0189312 A1, published Jul. 29, 2010, filed Feb. 5, 2010, and entitled “Methods and Apparatus for Overlaying Electronic Locate Information on Facilities Map Information and/or Other Image Information Displayed on a Locate Device;”
U.S. publication no. 2010-0188216 A1, published Jul. 29, 2010, filed Feb. 5, 2010, and entitled “Methods and Apparatus for Generating Alerts on a Locate Device, Based ON Comparing Electronic Locate Information TO Facilities Map Information and/or Other Image Information;”
U.S. publication no. 2010-0189887 A1, published Jul. 29, 2010, filed Feb. 11, 2010, and entitled “Marking Apparatus Having Enhanced Features for Underground Facility Marking Operations, and Associated Methods and Systems;”
U.S. publication no. 2010-0256825-A1, published Oct. 7, 2010, filed Jun. 9, 2010, and entitled “Marking Apparatus Having Operational Sensors For Underground Facility Marking Operations, And Associated Methods And Systems;”
U.S. publication no. 2010-0255182-A1, published Oct. 7, 2010, filed Jun. 9, 2010, and entitled “Marking Apparatus Having Operational Sensors For Underground Facility Marking Operations, And Associated Methods And Systems;”
U.S. publication no. 2010-0245086-A1, published Sep. 30, 2010, filed Jun. 9, 2010, and entitled “Marking Apparatus Configured To Detect Out-Of-Tolerance Conditions In Connection With Underground Facility Marking Operations, And Associated Methods And Systems;”
U.S. publication no. 2010-0247754-A1, published Sep. 30, 2010, filed Jun. 9, 2010, and entitled “Methods and Apparatus For Dispensing Marking Material In Connection With Underground Facility Marking Operations Based on Environmental Information and/or Operational Information;”
U.S. publication no. 2010-0262470-A1, published Oct. 14, 2010, filed Jun. 9, 2010, and entitled “Methods, Apparatus, and Systems For Analyzing Use of a Marking Device By a Technician To Perform An Underground Facility Marking Operation;”
U.S. publication no. 2010-0263591-A1, published Oct. 21, 2010, filed Jun. 9, 2010, and entitled “Marking Apparatus Having Environmental Sensors and Operations Sensors for Underground Facility Marking Operations, and Associated Methods and Systems;”
U.S. publication no. 2010-0188245 A1, published Jul. 29, 2010, filed Feb. 11, 2010, and entitled “Locate Apparatus Having Enhanced Features for Underground Facility Locate Operations, and Associated Methods and Systems;”
U.S. publication no. 2010-0253511-A1, published Oct. 7, 2010, filed Jun. 18, 2010, and entitled “Locate Apparatus Configured to Detect Out-of-Tolerance Conditions in Connection with Underground Facility Locate Operations, and Associated Methods and Systems;”
U.S. publication no. 2010-0257029-A1, published Oct. 7, 2010, filed Jun. 18, 2010, and entitled “Methods, Apparatus, and Systems For Analyzing Use of a Locate Device By a Technician to Perform an Underground Facility Locate Operation;”
U.S. publication no. 2010-0253513-A1, published Oct. 7, 2010, filed Jun. 18, 2010, and entitled “Locate Transmitter Having Enhanced Features For Underground Facility Locate Operations, and Associated Methods and Systems;”
U.S. publication no. 2010-0253514-A1, published Oct. 7, 2010, filed Jun. 18, 2010, and entitled “Locate Transmitter Configured to Detect Out-of-Tolerance Conditions In Connection With Underground Facility Locate Operations, and Associated Methods and Systems;”
U.S. publication no. 2010-0256912-A1, published Oct. 7, 2010, filed Jun. 18, 2010, and entitled “Locate Apparatus for Receiving Environmental Information Regarding Underground Facility Marking Operations, and Associated Methods and Systems;”
U.S. publication no. 2009-0204238-A1, published Aug. 13, 2009, filed Feb. 2, 2009, and entitled “Electronically Controlled Marking Apparatus and Methods;”
U.S. publication no. 2009-0208642-A1, published Aug. 20, 2009, filed Feb. 2, 2009, and entitled “Marking Apparatus and Methods For Creating an Electronic Record of Marking Operations;”
U.S. publication no. 2009-0210098-A1, published Aug. 20, 2009, filed Feb. 2, 2009, and entitled “Marking Apparatus and Methods For Creating an Electronic Record of Marking Apparatus Operations;”
U.S. publication no. 2009-0201178-A1, published Aug. 13, 2009, filed Feb. 2, 2009, and entitled “Methods For Evaluating Operation of Marking Apparatus;”
U.S. publication no. 2009-0238417-A1, published Sep. 24, 2009, filed Feb. 6, 2009, and entitled “Virtual White Lines for Indicating Planned Excavation Sites on Electronic Images;”
U.S. publication no. 2010-0205264-A1, published Aug. 12, 2010, filed Feb. 10, 2010, and entitled “Methods, Apparatus, and Systems for Exchanging Information Between Excavators and Other Entities Associated with Underground Facility Locate and Marking Operations;”
U.S. publication no. 2010-0205031-A1, published Aug. 12, 2010, filed Feb. 10, 2010, and entitled “Methods, Apparatus, and Systems for Exchanging Information Between Excavators and Other Entities Associated with Underground Facility Locate and Marking Operations;”
U.S. publication no. 2010-0259381-A1, published Oct. 14, 2010, filed Jun. 28, 2010, and entitled “Methods, Apparatus and Systems for Notifying Excavators and Other Entities of the Status of in-Progress Underground Facility Locate and Marking Operations;”
U.S. publication no. 2010-0262670-A1, published Oct. 14, 2010, filed Jun. 28, 2010, and entitled “Methods, Apparatus and Systems for Communicating Information Relating to the Performance of Underground Facility Locate and Marking Operations to Excavators and Other Entities;”
U.S. publication no. 2010-0259414-A1, published Oct. 14, 2010, filed Jun. 28, 2010, and entitled “Methods, Apparatus And Systems For Submitting Virtual White Line Drawings And Managing Notifications In Connection With Underground Facility Locate And Marking Operations;”
U.S. publication no. 2010-0268786-A1, published Oct. 21, 2010, filed Jun. 28, 2010, and entitled “Methods, Apparatus and Systems for Requesting Underground Facility Locate and Marking Operations and Managing Associated Notifications;”
U.S. publication no. 2010-0201706-A1, published Aug. 12, 2010, filed Jun. 1, 2009, and entitled “Virtual White Lines (VWL) for Delimiting Planned Excavation Sites of Staged Excavation Projects;”
U.S. publication no. 2010-0205555-A1, published Aug. 12, 2010, filed Jun. 1, 2009, and entitled “Virtual White Lines (VWL) for Delimiting Planned Excavation Sites of Staged Excavation Projects;”
U.S. publication no. 2010-0205195-A1, published Aug. 12, 2010, filed Jun. 1, 2009, and entitled “Methods and Apparatus for Associating a Virtual White Line (VWL) Image with Corresponding Ticket Information for an Excavation Project;”
U.S. publication no. 2010-0205536-A1, published Aug. 12, 2010, filed Jun. 1, 2009, and entitled “Methods and Apparatus for Controlling Access to a Virtual White Line (VWL) Image for an Excavation Project;”
U.S. publication no. 2010-0228588-A1, published Sep. 9, 2010, filed Feb. 11, 2010, and entitled “Management System, and Associated Methods and Apparatus, for Providing Improved Visibility, Quality Control and Audit Capability for Underground Facility Locate and/or Marking Operations;”
U.S. publication no. 2010-0324967-A1, published Dec. 23, 2010, filed Jul. 9, 2010, and entitled “Management System, and Associated Methods and Apparatus, for Dispatching Tickets, Receiving Field Information, and Performing A Quality Assessment for Underground Facility Locate and/or Marking Operations;”
U.S. publication no. 2010-0318401-A1, published Dec. 16, 2010, filed Jul. 9, 2010, and entitled “Methods and Apparatus for Performing Locate and/or Marking Operations with Improved Visibility, Quality Control and Audit Capability;”
U.S. publication no. 2010-0318402-A1, published Dec. 16, 2010, filed Jul. 9, 2010, and entitled “Methods and Apparatus for Managing Locate and/or Marking Operations;”
U.S. publication no. 2010-0318465-A1, published Dec. 16, 2010, filed Jul. 9, 2010, and entitled “Systems and Methods for Managing Access to Information Relating to Locate and/or Marking Operations;”
U.S. publication no. 2010-0201690-A1, published Aug. 12, 2010, filed Apr. 13, 2009, and entitled “Virtual White Lines (VWL) Application for Indicating a Planned Excavation or Locate Path;”
U.S. publication no. 2010-0205554-A1, published Aug. 12, 2010, filed Apr. 13, 2009, and entitled “Virtual White Lines (VWL) Application for Indicating an Area of Planned Excavation;”
U.S. publication no. 2009-0202112-A1, published Aug. 13, 2009, filed Feb. 11, 2009, and entitled “Searchable Electronic Records of Underground Facility Locate Marking Operations;”
U.S. publication no. 2009-0204614-A1, published Aug. 13, 2009, filed Feb. 11, 2009, and entitled “Searchable Electronic Records of Underground Facility Locate Marking Operations;”
U.S. publication no. 2011-0060496-A1, published Mar. 10, 2011, filed Aug. 10, 2010, and entitled “Systems and Methods for Complex Event Processing of Vehicle Information and Image Information Relating to a Vehicle;”
U.S. publication no. 2011-0093162-A1, published Apr. 21, 2011, filed Dec. 28, 2010, and entitled “Systems And Methods For Complex Event Processing Of Vehicle-Related Information;”
U.S. publication no. 2011-0093306-A1, published Apr. 21, 2011, filed Dec. 28, 2010, and entitled “Fleet Management Systems And Methods For Complex Event Processing Of Vehicle-Related Information Via Local And Remote Complex Event Processing Engines;”
U.S. publication no. 2011-0093304-A1, published Apr. 21, 2011, filed Dec. 29, 2010, and entitled “Systems And Methods For Complex Event Processing Based On A Hierarchical Arrangement Of Complex Event Processing Engines;”
U.S. publication no. 2010-0257477-A1, published Oct. 7, 2010, filed Apr. 2, 2010, and entitled “Methods, Apparatus, and Systems for Documenting and Reporting Events Via Time-Elapsed Geo-Referenced Electronic Drawings;”
U.S. publication no. 2010-0256981-A1, published Oct. 7, 2010, filed Apr. 2, 2010, and entitled “Methods, Apparatus, and Systems for Documenting and Reporting Events Via Time-Elapsed Geo-Referenced Electronic Drawings;”
U.S. publication no. 2010-0205032-A1, published Aug. 12, 2010, filed Feb. 11, 2010, and entitled “Marking Apparatus Equipped with Ticket Processing Software for Facilitating Marking Operations, and Associated Methods;”
U.S. publication no. 2011-0035251-A1, published Feb. 10, 2011, filed Jul. 15, 2010, and entitled “Methods, Apparatus, and Systems for Facilitating and/or Verifying Locate and/or Marking Operations;”
U.S. publication no. 2011-0035328-A1, published Feb. 10, 2011, filed Jul. 15, 2010, and entitled “Methods, Apparatus, and Systems for Generating Technician Checklists for Locate and/or Marking Operations;”
U.S. publication no. 2011-0035252-A1, published Feb. 10, 2011, filed Jul. 15, 2010, and entitled “Methods, Apparatus, and Systems for Processing Technician Checklists for Locate and/or Marking Operations;”
U.S. publication no. 2011-0035324-A1, published Feb. 10, 2011, filed Jul. 15, 2010, and entitled “Methods, Apparatus, and Systems for Generating Technician Workflows for Locate and/or Marking Operations;”
U.S. publication no. 2011-0035245-A1, published Feb. 10, 2011, filed Jul. 15, 2010, and entitled “Methods, Apparatus, and Systems for Processing Technician Workflows for Locate and/or Marking Operations;”
U.S. publication no. 2011-0035260-A1, published Feb. 10, 2011, filed Jul. 15, 2010, and entitled “Methods, Apparatus, and Systems for Quality Assessment of Locate and/or Marking Operations Based on Process Guides;”
U.S. publication no. 2010-0256863-A1, published Oct. 7, 2010, filed Apr. 2, 2010, and entitled “Methods, Apparatus, and Systems for Acquiring and Analyzing Vehicle Data and Generating an Electronic Representation of Vehicle Operations;”
U.S. publication no. 2011-0022433-A1, published Jan. 27, 2011, filed Jun. 24, 2010, and entitled “Methods and Apparatus for Assessing Locate Request Tickets;”
U.S. publication no. 2011-0040589-A1, published Feb. 17, 2011, filed Jul. 21, 2010, and entitled “Methods and Apparatus for Assessing Complexity of Locate Request Tickets;”
U.S. publication no. 2011-0046993-A1, published Feb. 24, 2011, filed Jul. 21, 2010, and entitled “Methods and Apparatus for Assessing Risks Associated with Locate Request Tickets;”
U.S. publication no. 2011-0046994-A1, published Feb. 17, 2011, filed Jul. 21, 2010, and entitled “Methods and Apparatus for Multi-Stage Assessment of Locate Request Tickets;”
U.S. publication no. 2011-0040590-A1, published Feb. 17, 2011, filed Jul. 21, 2010, and entitled “Methods and Apparatus for Improving a Ticket Assessment System;”
U.S. publication no. 2011-0020776-A1, published Jan. 27, 2011, filed Jun. 25, 2010, and entitled “Locating Equipment for and Methods of Simulating Locate Operations for Training and/or Skills Evaluation;”
U.S. publication no. 2010-0285211-A1, published Nov. 11, 2010, filed Apr. 21, 2010, and entitled “Method Of Using Coded Marking Patterns In Underground Facilities Locate Operations;”
U.S. publication no. 2011-0137769-A1, published Jun. 9, 2011, filed Nov. 5, 2010, and entitled “Method Of Using Coded Marking Patterns In Underground Facilities Locate Operations;”
U.S. publication no. 2009-0327024-A1, published Dec. 31, 2009, filed Jun. 26, 2009, and entitled “Methods and Apparatus for Quality Assessment of a Field Service Operation;”
U.S. publication no. 2010-0010862-A1, published Jan. 14, 2010, filed Aug. 7, 2009, and entitled, “Methods and Apparatus for Quality Assessment of a Field Service Operation Based on Geographic Information;”
U.S. publication No. 2010-0010863-A1, published Jan. 14, 2010, filed Aug. 7, 2009, and entitled, “Methods and Apparatus for Quality Assessment of a Field Service Operation Based on Multiple Scoring Categories;”
U.S. publication no. 2010-0010882-A1, published Jan. 14, 2010, filed Aug. 7, 2009, and entitled, “Methods and Apparatus for Quality Assessment of a Field Service Operation Based on Dynamic Assessment Parameters;”
U.S. publication no. 2010-0010883-A1, published Jan. 14, 2010, filed Aug. 7, 2009, and entitled, “Methods and Apparatus for Quality Assessment of a Field Service Operation Based on Multiple Quality Assessment Criteria;”
U.S. publication no. 2011-0007076-A1, published Jan. 13, 2011, filed Jul. 7, 2010, and entitled, “Methods, Apparatus and Systems for Generating Searchable Electronic Records of Underground Facility Locate and/or Marking Operations;”
U.S. publication no. 2011-0131081-A1, published Jun. 2, 2011, filed Oct. 29, 2010, and entitled “Methods, Apparatus, and Systems for Providing an Enhanced Positive Response in Underground Facility Locate and Marking Operations;”
U.S. publication no. 2011-0060549-A1, published Mar. 10, 2011, filed Aug. 13, 2010, and entitled, “Methods and Apparatus for Assessing Marking Operations Based on Acceleration Information;”
U.S. publication no. 2011-0117272-A1, published May 19, 2011, filed Aug. 19, 2010, and entitled, “Marking Device with Transmitter for Triangulating Location During Locate Operations;”
U.S. publication no. 2011-0045175-A1, published Feb. 24, 2011, filed May 25, 2010, and entitled, “Methods and Marking Devices with Mechanisms for Indicating and/or Detecting Marking Material Color;”
U.S. publication no. 2010-0088135 A1, published Apr. 8, 2010, filed Oct. 1, 2009, and entitled, “Methods and Apparatus for Analyzing Locate and Marking Operations with Respect to Environmental Landmarks;”
U.S. publication no. 2010-0085185 A1, published Apr. 8, 2010, filed Sep. 30, 2009, and entitled, “Methods and Apparatus for Generating Electronic Records of Locate Operations;”
U.S. publication no. 2011-0095885 A9 (Corrected Publication), published Apr. 28, 2011, and entitled, “Methods And Apparatus For Generating Electronic Records Of Locate Operations;”
U.S. publication no. 2010-0090700-A1, published Apr. 15, 2010, filed Oct. 30, 2009, and entitled “Methods and Apparatus for Displaying an Electronic Rendering of a Locate Operation Based on an Electronic Record of Locate Information;”
U.S. publication no. 2010-0085054 A1, published Apr. 8, 2010, filed Sep. 30, 2009, and entitled, “Systems and Methods for Generating Electronic Records of Locate And Marking Operations;” and
U.S. publication no. 2011-0046999-A1, published Feb. 24, 2011, filed Aug. 4, 2010, and entitled, “Methods and Apparatus for Analyzing Locate and Marking Operations by Comparing Locate Information and Marking Information.”

It should be appreciated that all combinations of the foregoing concepts and additional concepts discussed in greater detail below (provided such concepts are not mutually inconsistent) are contemplated as being part of the inventive subject matter disclosed herein. In particular, all combinations of claimed subject matter appearing at the end of this disclosure are contemplated as being part of the inventive subject matter disclosed herein. It should also be appreciated that terminology explicitly employed herein that also may appear in any disclosure incorporated by reference should be accorded a meaning most consistent with the particular concepts disclosed herein.

### BRIEF DESCRIPTION OF THE DRAWINGS

The present invention, both as to its organization and manner of operation, together with further objectives and advantages, may be best understood by reference to the following description, taken in connection with the accompanying drawings as set forth below:

FIG. 1 is a perspective view of an example of a locate operations system for automatically inserting symbols into electronic records of locate operations, according to embodiments of the invention;

FIG. 2 is a functional block diagram of an example of control electronics of a marking device used in the locate operations system, according to embodiments of the invention;

FIG. 3 is a top view of an example of a graphical representation of locate operations having symbols automatically inserted therein, according to embodiments of the invention;

FIG. 4 is a flow diagram of an example of a method of automatically inserting symbols into electronic records of locate operations and providing graphical representations thereof, according to embodiments of the invention; and

FIG. 5 is a flow diagram of another example of a method of automatically inserting symbols into electronic records of locate operations and providing graphical representations thereof, according to embodiments of the invention.

### DETAILED DESCRIPTION

Various embodiments of the present invention relate generally to a locate operations system for and methods of automatically inserting symbols into electronic records of locate operations. The locate operations system includes a geo-enabled electronic marking device that is capable of acquiring digital information about the marking operation (hereafter called marking data). Each sample of data in the marking data is timestamped and geo-referenced. By use of the marking data, electronic records of locate operations may be generated. Inserting symbols into the electronic records of locate operations allows, for example, the symbols to be rendered in corresponding graphical representations of locate operations. Symbols information relating to such symbols may be distinguished from other data in the electronic data of locate operations. For example, the symbols information may be rendered as a separate layer in any graphical representations of locate operations.

Symbols may be any marks that communicate information other than a lines pattern for indicating the location of facilities. Examples of symbols may include, but are not limited to, alphanumeric characters (e.g., letters and numbers) and geometric symbols (e.g., circles, squares, rectangles, diamonds, lines, etc). In one example, a symbol indicates the owner of the facility being marked. For example, a gas facility owned by Washington Gas, which is a subsidiary of WGL Holdings, Inc. (Washington, D.C.), may be labeled with the symbol “WGL.” In this example, “WGL” may be inserted into the electronic record periodically along the lines pattern that indicates the location of the gas facility. In another example, a diamond symbol indicates that a group of facilities are running together in a conduit or in a common trench. In this example, the diamond symbol may be inserted into the electronic record periodically along the lines patterns that indicate the location of this group of facilities.

In one embodiment of the present invention, a software application that may operate separately from the marking device (1) reads the locate operation work order information, (2) reads the associated raw marking data, (3) processes both the locate operation work order information and the raw marking data, (4) determines the symbols to be inserted into the electronic record of the locate operation, (5) processes the electronic record that has symbols automatically inserted therein by, for example, rendering a graphical representation of the locate operation, and (6) saves the graphical representation of the locate operation rendered from the electronic record that has symbols automatically inserted therein. In this example, substantially all data processing to automatically insert the symbols is performed by the software application that is receiving the locate operation work order information and raw marking data. That is, the data processing capability for automatically inserting the symbols is provided separately from the marking device, such that no special data processing capability is required at the marking device.

In another embodiment of the present invention, a software application on the marking device (1) reads the locate operation work order information, (2) reads the associated raw marking data, (3) processes both the locate operation work order information and the raw marking data, (4) determines the symbols data to be inserted into the raw marking data that will be used to generate the electronic record of locate operations, (5) automatically modifies the raw marking data to include the symbols data, and (6) saves the modified marking data. In this embodiment, a separate software application, such as an image viewer application, may read the modified marking data that includes the symbols data. The software application may then present the modified marking data by rendering a graphical representation of the locate operations, which includes automatically rendering the symbols data in the modified marking data. In this example, substantially all data processing to automatically insert the symbols data is performed by a software application on the marking device. That is, the data processing capability for automatically inserting the symbols resides at the marking device, such that no special data processing capability is required at the viewer application that receives and renders the modified marking data.

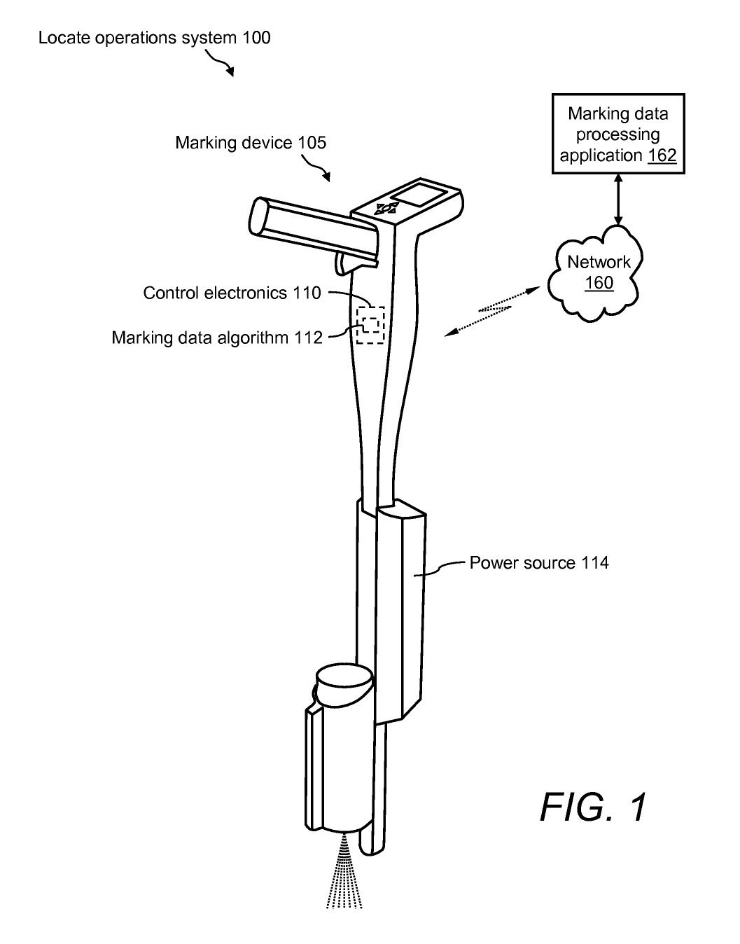

FIG. 1 is a perspective view of an example of a locate operations system 100 for automatically inserting symbols into electronic records of locate operations. More specifically, FIG. 1 shows a geo-enabled marking device 105 that is capable of acquiring marking data representative of locate operations performed with the marking device.

In one example, marking device 105 may be the geo-enabled electronic marking device described in U.S. Patent Publication No. 2010/0088032 entitled “Methods, Apparatus, and Systems for Generating Electronic Records of Locate and Marking Operations, and Combined Locate and Marking Apparatus for Same”, which is incorporated herein by reference in its entirety. Such geo-enabled electronic marking devices may include input devices, such as, but not limited to, one or more of the following types of devices: a marking material detection mechanism, a location tracking system, a temperature sensor, a humidity sensor, a light sensor, an electronic compass, an inclinometer, an accelerometer, an image capture device, and an audio recorder.

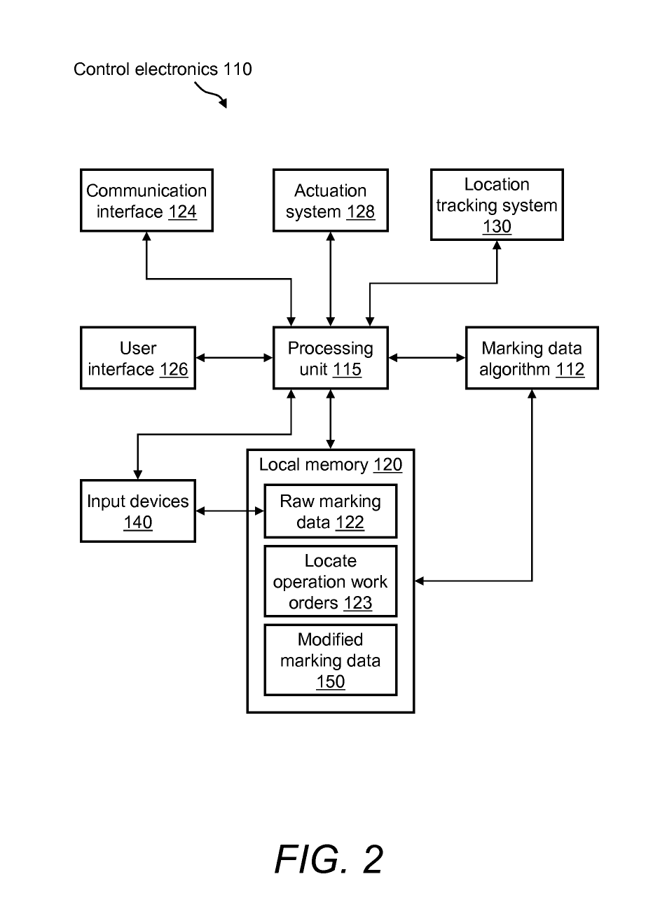

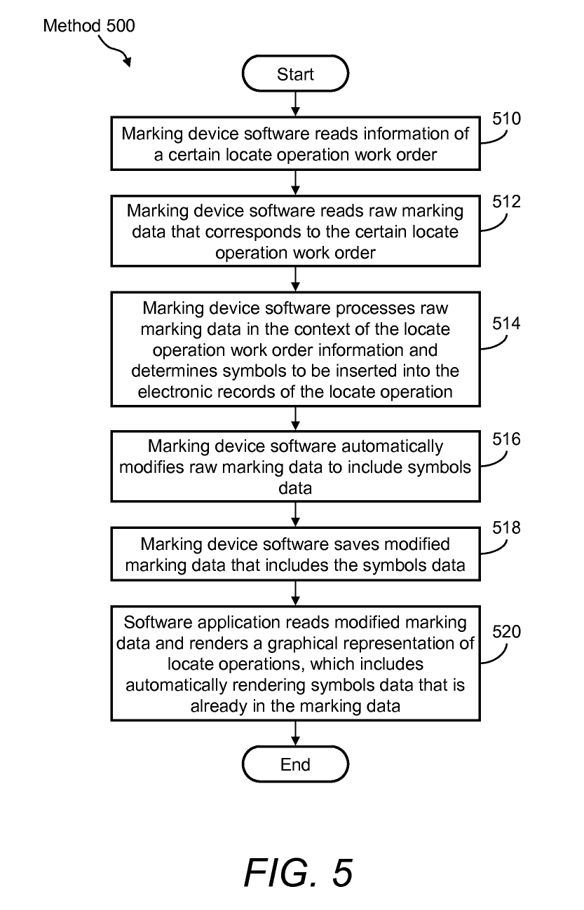

In particular, marking device 105 may be a geo-enabled electronic marking device, which is enhanced to support locate operations system 100 for automatically inserting symbols into electronic records of locate operations. For example, marking device 105 may include control electronics 110 that includes a marking data algorithm 112 for automatically inserting symbols data into the marking data thereof. Details of control electronics 110 are described with reference to FIG. 2. Details of the use of marking data algorithm 112 are described with reference to FIG. 5.

The components of marking device 105 may be powered by a power source 114. Power source 114 may be any power source that is suitable for use in a portable device, such as, but not limited to, one or more rechargeable batteries, one or more non-rechargeable batteries, a solar electrovoltaic panel, a standard AC power plug feeding an AC-to-DC converter, and the like.

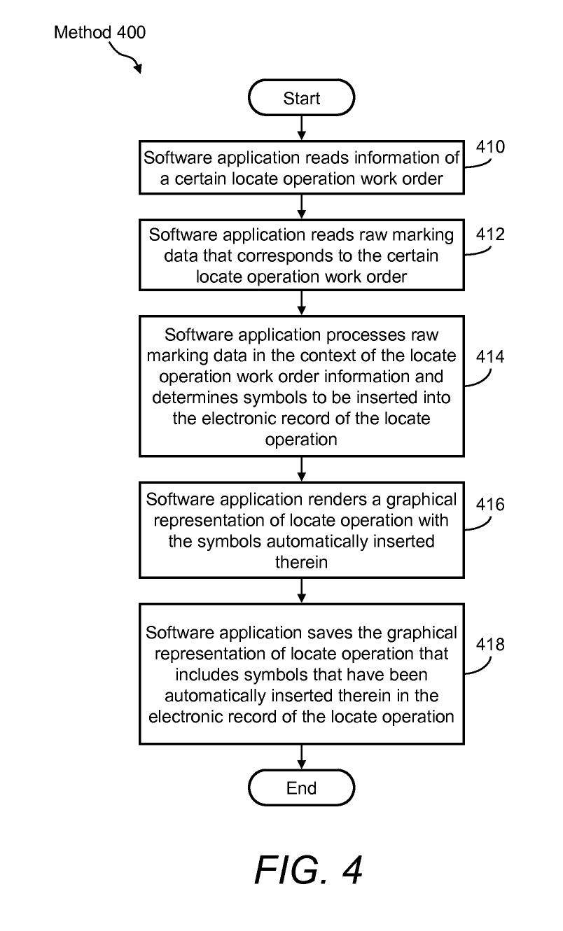

Additionally, locate operations system 100 may include a network 160 by which marking device 105 may communicate in a wired and/or wireless fashion with remote computing devices. Network 160 may be, for example, a local area network (LAN) or a wide area network (WAN). In one example, marking device 105 may communicate via network 160 with a marking data processing application 162. Marking data processing application 162 may be a software application that resides on a computer (not shown) that is remote to marking device 105. Details of marking data processing application 162 are described with reference to FIGS. 4 and 5.

FIG. 2 is a functional block diagram of an example of control electronics 110 of marking device 105 of locate operations system 100. In this example, control electronics 110 may include, but is not limited to, the marking data algorithm 112 shown in FIG. 1, a processing unit 115, a local memory 120, a communication interface 124, a user interface 126, an actuation system 128, and a location tracking system 130.

Processing unit 115 may be any general-purpose processor, controller, or microcontroller device that is capable of managing the overall operations of marking device 105, including managing data returned from components thereof. Local memory 120 may be any volatile or non-volatile data storage device, such as, but not limited to, a random access memory (RAM) device and a removable memory device (e.g., a universal serial bus (USB) flash drive). An example of information that is stored in local memory 120 is raw marking data 122. The contents of raw marking data 122 may include digital information about a marking operation. Additionally, locate operation work orders 123, which are provided in electronic form, may be stored in local memory 120. Locate operation work orders 123 may be any work orders for locate services that are submitted to the locate company.

Communication interface 124 may be any wired and/or wireless communication interface for connecting to a network (not shown) and by which information (e.g., the contents of local memory 120) may be exchanged with other devices connected to the network. Examples of wired communication interfaces may include, but are not limited to, USB ports, RS232 connectors, RJ45 connectors, Ethernet, and any combinations thereof. Examples of wireless communication interfaces may include, but are not limited to, an Intranet connection, Internet, Bluetooth® technology, Wi-Fi, Wi-Max, IEEE 802.11 technology, radio frequency (RF), Infrared Data Association (IrDA) compatible protocols, Local Area Networks (LAN), Wide Area Networks (WAN), Shared Wireless Access Protocol (SWAP), any combinations thereof, and other types of wireless networking protocols.

User interface 126 may be any mechanism or combination of mechanisms by which the user may operate marking device 105 and by which information that is generated by marking device 105 may be presented to the user. For example, user interface 126 may include, but is not limited to, a display, a touch screen, one or more manual pushbuttons, one or more light-emitting diode (LED) indicators, one or more toggle switches, a keypad, an audio output (e.g., speaker, buzzer, and alarm), and any combinations thereof.

Actuation system 128 may include a mechanical and/or electrical actuator mechanism (not shown) that may be coupled to an actuator that causes the marking material to be dispensed from the marking dispenser of marking device 105. Additionally, actuation system 128 may be the mechanism that prompts the logging of data of interest in raw marking data 122 of local memory 120. Actuation means starting or causing marking device 105 to work, operate, and/or function. Examples of actuation may include, but are not limited to, local or remote, physical, audible, inaudible, visual, non-visual, electronic, electromechanical, biomechanical, biosensing or other signal, instruction, or event. Actuations of marking device 105 may be performed for any purpose, such as, but not limited to, for dispensing marking material and for capturing information from one or more components of marking device 105 without dispensing marking material.

In one example, an actuation may occur by pulling or pressing a physical trigger of marking device 105, which causes the marking material to be dispensed. In this example, each time the trigger of marking device 105 is actuated, any available information that is associated with the actuation event is acquired and raw marking data 122 is updated accordingly.

Location tracking system 130 may include any device that can determine its geographical location to a certain degree of accuracy. For example, location tracking system 130 may include a GPS receiver or a global navigation satellite system (GNSS) receiver. A GPS receiver may provide, for example, any standard format data stream, such as a National Marine Electronics Association (NMEA) data stream. Location tracking system 130 may also include an error correction component (not shown), which may be any mechanism for improving the accuracy of the geo-location data. Geo-location data from location tracking system 130 is an example of information that may be stored in raw marking data 122.

Additionally, control electronics 110 may include input devices 140. Input devices 140 are useful for acquiring and/or generating marking data that may be used for indicating and recording the operations of marking device 105. For example, input devices 140 of marking device 105 may include, but are not limited to, one or more of the following types of devices: a marking material detection mechanism, a temperature sensor, a humidity sensor, a light sensor, an electronic compass, an inclinometer, an accelerometer, an image capture device, and an audio recorder. Digital information that is acquired and/or generated by input devices 140 may be stored in raw marking data 122 of local memory 120. Each acquisition of data from input devices 140 is stored with a timestamp (i.e., date/time information).

The marking material detection mechanism may be any mechanism for determining attributes of the marking material that is being dispensed by the marking device. In one example, the marking material detection mechanism may include radio-frequency identification (RFID) technology for reading information of an RFID tag that is provided on the marking material dispenser. In another example, the marking material detection mechanism may be any of the marking material detection mechanisms described in U.S. Patent Publication No. 2010/0006667, entitled “Marker Detection Mechanism for use in Marking Devices and Methods of Using Same,” which is incorporated herein by reference in its entirety. Marking material color data from the marking material detection mechanism is another example of information that may be stored in raw marking data 122.

The temperature sensor, humidity sensor, and light sensor are examples of environmental sensors for capturing the environmental conditions in which marking device 105 is used. Temperature data from the temperature sensor, humidity data from the humidity sensor, and light intensity data from the light sensor are examples of information that may be stored in raw marking data 122.

An inclinometer is an instrument for measuring angles of slope (or tilt) or inclination of an object with respect to gravity. In one example, the inclinometer may be a multi-axis digital device for sensing the inclination of marking device 105. Inclinometer data from the inclinometer is yet another example of information that may be stored in raw marking data 122.

An accelerometer is a device for measuring acceleration and gravity-induced reaction forces. In one example, a multi-axis accelerometer (e.g., 3-axis accelerometer) may be utilized to determine the motion (e.g., rate of movement) of marking device 105. The acceleration specification may be in terms of g-force, which is a measurement of an object's acceleration. Accelerometer data from the accelerometer is yet another example of information that may be stored in raw marking data 122.

The electronic compass may be any electronic compass device for providing the directional heading of marking device 105. The heading means the direction toward which the electronic compass is moving, such as north, south, east, west, and any combinations thereof. Heading data from the electronic compass is yet another example of information that may be stored in raw marking data 122.

For each actuation of marking device 105, a record of information is stored in raw marking data 122. That is, for each mark that is dispensed by marking device 105, a record of information is stored in raw marking data 122. For example, at each actuation of actuation system 128 of marking device 105, information from input devices 140, such as, but not limited to, marking material color data, temperature data, humidity data, light intensity data, inclinometer data, accelerometer data, and heading data, as well as geo-location data from location tracking system 130, is timestamped and logged in raw marking data 122.

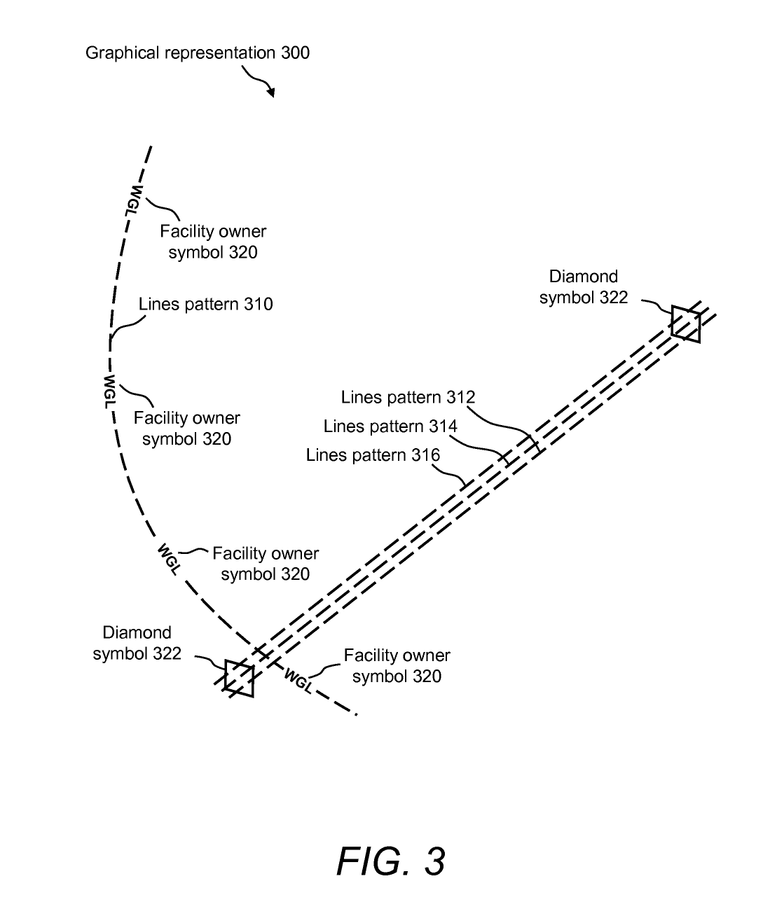

FIG. 3 is a top view of an example of a graphical representation 300 of locate operations. Graphical representation 300 is an example of the presentation of an electronic record of locate operations that has symbols automatically inserted therein by use of locate operations system 100. Graphical representation 300 may be generated from raw marking data 122 for a locate operation. In this example, graphical representation 300 shows a lines pattern 310, which indicates the location of a first facility; a lines pattern 312, which indicates the location of a second facility; a lines pattern 314, which indicates the location of a third facility; and a lines pattern 316, which indicates the location of a fourth facility. In this example, lines pattern 310 indicates a gas facility that is owned by Washington Gas. Therefore, one or more facility owner symbols 320 are shown along lines pattern 310. In this example, each facility owner symbol 320 is the “WGL” symbol.

Additionally, lines pattern 312, lines pattern 314, and lines pattern 316 indicate a group of facilities that run together in a conduit or in a common trench. Therefore, one or more diamond symbols 322 are shown along the group of lines pattern 312, lines pattern 314, and lines pattern 316.

In the example of graphical representation 300, facility owner symbols 320 and diamond symbols 322 may be automatically inserted in the graphical representation that is rendered from raw marking data 122 according, for example, to one of two methods. More specifically, method 400 of FIG. 4 shows a first method of automatically inserting symbols into the electronic record of a locate operation and providing a graphical representation thereof, and method 500 of FIG. 5 shows a second method of automatically inserting symbols into the electronic record of a locate operation and providing a graphical representation thereof.

FIG. 4 is a flow diagram of an example of a method 400 of automatically inserting symbols into electronic records of locate operations and providing graphical representations thereof. In particular, FIG. 4 shows a method of automatically inserting the symbols into the electronic record by use of marking data processing application 162, which is a software application running outside of marking device 105, as shown in FIG. 1. In this example, substantially all data processing for automatically inserting the symbols into the electronic records is performed by marking data processing application 162.

With respect to performing method 400, marking data processing application 162 receives information from locate operation work order 123 and also receives from marking device 105 the raw marking data 122 that corresponds to the locate operation work order 123. Further, in this example, no special data processing capability is required at marking device 105, because the data processing is performed by marking data processing application 162.

Marking data processing application 162 may be, for example, a software application for processing raw marking data 122 from marking device 105 in the context of information from the locate operation work order 123. The data processing capability of marking data processing application 162 may be based on a software application for rendering a graphical representation of locate operations described in U.S. Patent Publication No. 2010/0086677, entitled, “Methods and Apparatus for Generating an Electronic Record of a Marking Operation Based on Marking Device Actuations”, which is incorporated herein by reference in its entirety.

Further, marking data processing application 162 may have image rendering and/or viewing capability. The image rendering and/or viewing capability of marking data processing application 162 may be based on an electronic manifest (EM) application described in U.S. Patent Publication No. 2009/0202101, entitled “Electronic Manifest of Underground Facility Locate Marks,” which is incorporated herein by reference in its entirety. The electronic manifest application is an electronic drawing tool that may be used by locate technicians for electronically marking up, for example, a digital aerial image of the dig area for indicating locate marks that have been dispensed at the site, thereby indicating the geo-locations and types of facilities present. The output of the EM application may be referred to as an “electronic manifest” or searchable electronic record of the locate operations.

In one example, method 400 may be performed after the completion of a locate operation. Referring again to FIG. 4, method 400 may include, but is not limited to, the following acts, which are not limited to any order.

In act 410, a software application, such as marking data processing application 162 of FIG. 1, reads information from locate operation work order 123 in local memory 120. The work order information may be transmitted from marking device 105 to marking data processing application 162 via network 160. The work order information may include, but is not limited to, the name of the requesting party, the location (e.g., address) of the requested locate operation, a “complete by” date, the types of facilities to be located, the owners of the facilities to be located, and the like.

In act 412, marking data processing application 162 reads the raw marking data 122 in local memory 120 that corresponds to locate operation work order 123. The raw marking data 122 may be transmitted from marking device 105 to marking data processing application 162 via network 160. Raw marking data 122 includes a record of data for each mark dispensed by marking device 105 during the locate operation. For example, raw marking data 122 may include, but is not limited to, marking material color data, temperature data, humidity data, light intensity data, inclinometer data, accelerometer data, heading data, geo-location data, and timestamp data.

In act 414, marking data processing application 162 processes the raw marking data 122 in the context of the information from locate operation work order 123 and determines the symbols to be inserted into the electronic record thereof to be presented, for example, as a graphical representation of the locate operation. In one example and referring to graphical representation 300 of FIG. 3, marking data processing application 162 processes the raw marking data 122 and identifies lines pattern 310, lines pattern 312, lines pattern 314, and lines pattern 316. From the marking material color data for each line that is identified, marking data processing application 162 may determine the type of facility that was marked according to Table 1 below. For example, the marking material color data for lines pattern 310 may be yellow, which indicates that lines pattern 310 represents a gas facility.

TABLE 1
Correlation of marking material color to facility type

| Marking | |
|---|---|
| material color | Facility Type |
| White | Proposed excavation |
| Pink | Temporary survey markings |
| Red | Electric power lines, cables or conduits, and lighting |
| | cables |
| Yellow | Gas, oil, steam, petroleum, or other hazardous liquid or |
| | gaseous materials |
| Orange | Communications, cable TV, alarm or signal lines, cables, |
| | or conduits |
| Blue | Water, irrigation, and slurry lines |
| Purple | Reclaimed water, irrigation and slurry lines |
| Green | Sewers, storm sewer facilities, or other drain lines |
| Black | Mark-out for errant lines |

Marking data processing application 162 may interrogate the locate operation work order and determine that the gas facility owner is Washington Gas. Marking data processing application 162 may then use a lookup table (not shown) to determine the symbol for Washington Gas. Additionally, marking data processing application 162 may determine the symbol for Washington Gas by the member code that is found in the locate operation work order. Additionally, a user may be prompted to manually enter the member code and/or select the symbol type.

Continuing act 414, from the marking material color data for each line that is identified and from information in Table 1, marking data processing application 162 may also determine the type of facilities represented by lines pattern 312, lines pattern 314, and lines pattern 316. In one example, lines pattern 312 is red and indicates electric power lines, lines pattern 314 is orange and indicates telephone lines, and lines pattern 316 is orange and indicates cable TV lines. Further, marking data processing application 162 analyzes the positions of lines pattern 312, lines pattern 314, and lines pattern 316 and/or information of locate operation work order 123 and determines that lines pattern 312, lines pattern 314, and lines pattern 316 indicate facilities that run together in a conduit or in a common trench. From this information, it is determined that one or more diamond symbols are to be rendered with respect to lines pattern 312, lines pattern 314, and lines pattern 316. In another example, marking data processing application 162 may determine from the types of facilities identified on the work order that predetermined symbols are to be inserted in the electronic record. For example, a predetermined symbol may indicate a high profile facility such as a gas line or a fiber optic line.

In act 416, marking data processing application 162 presents the electronic record that has symbols automatically inserted therein by rendering a graphical representation thereof. Using the symbols that were determined in act 414, marking data processing application 162 automatically renders the appropriate symbols in the graphical representation of the locate operation. In the example of FIG. 3, lines pattern 310 of graphical representation 300 has been determined to be a gas line owned by Washington Gas, and marking data processing application 162 automatically renders facility owner symbol 320, which is “WGL,” one or more times along lines pattern 310. The number of times in which facility owner symbol 320 is rendered may be programmable. In one example, facility owner symbol 320 is rendered twice—once at each end of lines pattern 310. In another example, facility owner symbol 320 is rendered three times—at each end and at the middle of lines pattern 310. In yet another example, facility owner symbol 320 is rendered multiple times at set points along the length of lines pattern 310 (e.g., at the 5%, 33%, 67%, and 95% points along the length).

In yet another example, facility owner symbol 320 may be rendered according to state, local, and/or regional regulations with respect to underground facility locate operations; locate service provider policy information; locate customer contractual information; locate customer requirements; standard operating procedures (SOP) with respect to locate operations, and the like. Additionally, facility owner symbol 320 may be rendered according to guidelines from any other sources, such as, but not limited to, the “Best Practices Version 5.0” document developed by the Common Ground Alliance (CGA) of Alexandria, Va. and the “Recommended Marking Guidelines For Underground Utilities” as endorsed by the National Utility Locating Contractors Association (NULCA) of North Kansas City, Mo. For example, these guidelines may specify that symbols are to be marked every 50 feet for a run of 1000 feet or greater. Facility owner symbol 320 may be rendered by data processing application 162 according to these guidelines.

Optionally, a feature of marking data processing application 162 may allow the user to override the automated rendering of symbols. In this case, the user may manually insert facility owner symbols 320 in, for example, the electronic representation of locate operations, such as graphical representation 300 of FIG. 3.

In the example of lines pattern 312, lines pattern 314, and lines pattern 316 of graphical representation 300 of FIG. 3 that have been determined to indicate facilities that run together in a conduit or in a common trench, marking data processing application 162 renders diamond symbol 322, which indicates a conduit or a common trench, one or more times along the group of lines pattern 312, lines pattern 314, and lines pattern 316. The number of times in which diamond symbol 322 is rendered may be programmable. In one example, diamond symbol 322 is rendered twice—once at each end of the group of lines patterns. In another example, diamond symbol 322 is rendered three times—at each end and at the middle of the group of lines patterns. In yet another example, diamond symbol 322 is rendered multiple times at set points along the length of the group of lines patterns (e.g., at the 5%, 33%, 67%, and 95% points along the length).

In yet another example, diamond symbol 322 may be rendered according to state, local, and/or regional regulations with respect to underground facility locate operations; locate service provider policy information; locate customer contractual information; locate customer requirements; SOPs with respect to locate operations, any other sources of guidelines, and the like. Optionally, the user may manually insert diamond symbols 322 in, for example, the electronic representation of locate operations, such as graphical representation 300 of FIG. 3.

In act 418, marking data processing application 162 saves the graphical representation of the locate operation which includes symbols that have been automatically inserted therein as part of the electronic record of the locate operation. For example and referring again to FIG. 3, marking data processing application 162 saves graphical representation 300 which includes facility owner symbols 320 and diamond symbols 322 that have been automatically inserted therein as part of the electronic record of the locate operation. The graphical representations of locate operations that includes symbols that have been automatically inserted may be saved in any standard digital image file format, such as JPG file format.

FIG. 5 is a flow diagram of another example of a method 500 of automatically inserting symbols into electronic records of locate operations and providing graphical representations thereof. In particular, FIG. 5 shows a method of automatically inserting the symbols into the electronic records of locate operations by use of marking data algorithm 112, which is a software application on marking device 105, as shown in FIGS. 1 and 2.

In this example, substantially all data processing to automatically insert the symbols is performed by marking data algorithm 112 at marking device 105.

With respect to performing method 500, marking data algorithm 112 receives information from locate operation work order 123 and also receives from marking device 105 the raw marking data 122 that corresponds to the locate operation work order 123. Further, in this example, the data processing capability for automatically inserting the symbols is resides at marking device 105, whereas no special data processing capability is required at the viewer application that is receiving and rendering the marking data. In one example, the viewer application may be marking data processing application 162.

Marking data algorithm 112 may be, for example, an algorithm that is capable of processing raw marking data 122 from marking device 105 in the context of information from the locate operation work order 123. In one example, marking data algorithm 112 may be based on the marking data algorithm described in U.S. Patent Publication No. 2010/0086677, entitled, “Methods and Apparatus for Generating an Electronic Record of a Marking Operation Based on Marking Device Actuations”, which is incorporated herein by reference in its entirety.

In one example, method 500 may be performed after the completion of a locate operation. Referring again to FIG. 5, method 500 may include, but is not limited to, the following acts, which are not limited to any order.

In act 510, a software application at marking device 105, such as marking data algorithm 112, reads information from locate operation work order 123 that resides in local memory 120. The work order information may include, but is not limited to, the name of the requesting party, the location (e.g., address) of the requested locate operation, a “complete by” date, the types of facilities to be located, the owners of the facilities to be located, and the like.

In act 512, marking data algorithm 112 reads the raw marking data 122 that resides in local memory 120 and that corresponds to locate operation work order 123. Raw marking data 122 includes a record of data for each mark that is dispensed by marking device 105 during the locate operation. For example, raw marking data 122 may include, but is not limited to, marking material color data, temperature data, humidity data, light intensity data, inclinometer data, accelerometer data, heading data, geo-location data, and timestamp data.

In act 514, marking data algorithm 112 processes the raw marking data 122 in the context of the information from locate operation work order 123 and determines the symbols to be inserted into the electronic record thereof to be presented, for example, as a graphical representation of the locate operation. In one example and referring to graphical representation 300 of FIG. 3, marking data algorithm 112 processes the raw marking data 122 and identifies the marks of lines patterns, e.g., lines pattern 310, lines pattern 312, lines pattern 314, and lines pattern 316 of FIG. 3. From the marking material color data for each lines pattern that is identified, marking data algorithm 112 may determine the type of facility that was marked according to Table 1 above. For example, the marking material color data for a lines pattern may be yellow, which indicates that lines pattern represents a gas facility.

Marking data algorithm 112 may interrogate the work order information and determine that the gas facility owner is Washington Gas. Marking data algorithm 112 may then use a lookup table (not shown) to determine the symbol for Washington Gas. The lookup table indicates that symbols data for one or more “WGL” symbols is to be inserted into the marking data for the gas lines pattern that is identified. Additionally, marking data processing application 162 may determine the symbol for Washington Gas by the member code that is found in the locate operation work order 123. Additionally, a user may be prompted to manually enter the member code and/or select the symbol type.

Continuing act 514, from the marking material color data for each line that is identified and from information in Table 1, marking data algorithm 112 may also determine the type of facilities represented by the lines patterns that are identified. In one example and referring to FIG. 3, lines pattern 312 is red and indicates electric power lines, lines pattern 314 is orange and indicates telephone lines, and lines pattern 316 is orange and indicates cable TV lines. Further, marking data algorithm 112 analyzes the positions of lines pattern 312, lines pattern 314, and lines pattern 316 and/or information of locate operation work order 123 and determines that lines pattern 312, lines pattern 314, and lines pattern 316 run together in a conduit or in a common trench. From this information, it is determined that one or more diamond symbols are to be inserted into the raw marking data 122 for these lines patterns that are identified.

In act 516, marking data algorithm 112 automatically modifies the raw marking data to include symbols data. For example, using the symbols that were determined in step 514, marking data algorithm 112 automatically inserts the appropriate symbols data into the raw marking data 122 of the locate operation. For example, the symbols data may be inserted as a separate layer of raw marking data 122. In the example of the lines pattern determined to be a gas line owned by Washington Gas, marking data algorithm 112 interrogates the geo-location data in the raw marking data 122 for dispensing patterns that substantially match the signature of, for example, “WGL” symbols. Upon identifying the actual “WGL” symbols that were dispensed and logging the actual geo-locations thereof, marking data algorithm 112 then inserts “WGL” symbols data, which are geo-referenced, into the raw marking data 122 to be rendered (in act 520) at the actual locations at which they were dispensed.

Similarly, in the example of the lines patterns determined to indicate facilities that run together in a conduit or in a common trench, marking data algorithm 112 interrogates the geo-location data in the raw marking data 122 for dispensing patterns that substantially match the signature of, for example, diamond symbols. Upon identifying the actual diamond symbols that were dispensed and logging the actual geo-locations thereof, marking data algorithm 112 then inserts diamond symbols data, which are geo-referenced, into the raw marking data 122 to be rendered (in act 520) at the actual locations at which they were dispensed. Again, the symbols data may be inserted as a separate layer of raw marking data 122.

In act 518, marking data algorithm 112 saves in local memory 120 the raw marking data 122 that has been modified with symbols data as modified marking data 150.

In act 520, a software application that has image rendering and/or viewing capability, such as marking data processing application 162, reads modified marking data 150 and then renders a graphical representation of the locate operations, which includes automatically rendering symbols data in modified marking data 150. In one example, modified marking data 150 may be transmitted from marking device 105 to marking data processing application 162 via network 160. Marking data processing application 162 then reads modified marking data 150 and renders, for example, graphical representation 300 of FIG. 3. In this example, marking data processing application 162 renders graphical representation 300 of FIG. 3 directly from modified marking data 150 that includes the symbols data without any further processing of the information in modified marking data 150. Thus, symbols may be automatically inserted into graphical representations of locate operations, which may be saved as part of electronic records of locate operations.

While various inventive embodiments have been described and illustrated herein, those of ordinary skill in the art will readily envision a variety of other means and/or structures for performing the function and/or obtaining the results and/or one or more of the advantages described herein, and each of such variations and/or modifications is deemed to be within the scope of the inventive embodiments described herein. More generally, those skilled in the art will readily appreciate that all parameters, dimensions, materials, and configurations described herein are meant to be exemplary and that the actual parameters, dimensions, materials, and/or configurations will depend upon the specific application or applications for which the inventive teachings is/are used. Those skilled in the art will recognize, or be able to ascertain using no more than routine experimentation, many equivalents to the specific inventive embodiments described herein. It is, therefore, to be understood that the foregoing embodiments are presented by way of example only and that, within the scope of the appended claims and equivalents thereto, inventive embodiments may be practiced otherwise than as specifically described and claimed. Inventive embodiments of the present disclosure are directed to each individual feature, system, article, material, kit, and/or method described herein. In addition, any combination of two or more such features, systems, articles, materials, kits, and/or methods, if such features, systems, articles, materials, kits, and/or methods are not mutually inconsistent, is included within the inventive scope of the present disclosure.

The above-described embodiments can be implemented in any of numerous ways. For example, the embodiments may be implemented using hardware, software or a combination thereof. When implemented in software, the software code can be executed on any suitable processor or collection of processors, whether provided in a single computer or distributed among multiple computers.

Further, it should be appreciated that a computer may be embodied in any of a number of forms, such as a rack-mounted computer, a desktop computer, a laptop computer, or a tablet computer. Additionally, a computer may be embedded in a device not generally regarded as a computer but with suitable processing capabilities, including a Personal Digital Assistant (PDA), a smart phone or any other suitable portable or fixed electronic device.

Also, a computer may have one or more input and output devices. These devices can be used, among other things, to present a user interface. Examples of output devices that can be used to provide a user interface include printers or display screens for visual presentation of output and speakers or other sound generating devices for audible presentation of output. Examples of input devices that can be used for a user interface include keyboards, and pointing devices, such as mice, touch pads, and digitizing tablets. As another example, a computer may receive input information through speech recognition or in other audible format.

Such computers may be interconnected by one or more networks in any suitable form, including a local area network or a wide area network, such as an enterprise network, an intelligent network (IN) or the Internet. Such networks may be based on any suitable technology and may operate according to any suitable protocol and may include wireless networks, wired networks or fiber optic networks.

Any computer discussed herein may comprise a memory, one or more processing units (also referred to herein simply as “processors”), one or more communication interfaces, one or more display units, and one or more user input devices (user interfaces). The memory may comprise any computer-readable media, and may store computer instructions (also referred to herein as “processor-executable instructions”) for implementing the various functionalities described herein. The processing unit(s) may be used to execute the instructions. The communication interface(s) may be coupled to a wired or wireless network, bus, or other communication means and may therefore allow the computer to transmit communications to and/or receive communications from other devices. The display unit(s) may be provided, for example, to allow a user to view various information in connection with execution of the instructions. The user input device(s) may be provided, for example, to allow the user to make manual adjustments, make selections, enter data or various other information, and/or interact in any of a variety of manners with the processor during execution of the instructions.

The various methods or processes outlined herein may be coded as software that is executable on one or more processors that employ any one of a variety of operating systems or platforms. Additionally, such software may be written using any of a number of suitable programming languages and/or programming or scripting tools, and also may be compiled as executable machine language code or intermediate code that is executed on a framework or virtual machine.

In this respect, various inventive concepts may be embodied as a computer readable storage medium (or multiple computer readable storage media) (e.g., a computer memory, one or more floppy discs, compact discs, optical discs, magnetic tapes, flash memories, circuit configurations in Field Programmable Gate Arrays or other semiconductor devices, or other non-transitory medium or tangible computer storage medium) encoded with one or more programs that, when executed on one or more computers or other processors, perform methods that implement the various embodiments of the invention discussed above. The computer readable medium or media can be transportable, such that the program or programs stored thereon can be loaded onto one or more different computers or other processors to implement various aspects of the present invention as discussed above.

The terms “program” or “software” are used herein in a generic sense to refer to any type of computer code or set of computer-executable instructions that can be employed to program a computer or other processor to implement various aspects of embodiments as discussed above. Additionally, it should be appreciated that according to one aspect, one or more computer programs that when executed perform methods of the present invention need not reside on a single computer or processor, but may be distributed in a modular fashion amongst a number of different computers or processors to implement various aspects of the present invention.

Computer-executable instructions may be in many forms, such as program modules, executed by one or more computers or other devices. Generally, program modules include routines, programs, objects, components, data structures, etc. that perform particular tasks or implement particular abstract data types. Typically the functionality of the program modules may be combined or distributed as desired in various embodiments.

Also, data structures may be stored in computer-readable media in any suitable form. For simplicity of illustration, data structures may be shown to have fields that are related through location in the data structure. Such relationships may likewise be achieved by assigning storage for the fields with locations in a computer-readable medium that convey relationship between the fields. However, any suitable mechanism may be used to establish a relationship between information in fields of a data structure, including through the use of pointers, tags or other mechanisms that establish relationship between data elements.

Also, various inventive concepts may be embodied as one or more methods, of which an example has been provided. The acts performed as part of the method may be ordered in any suitable way. Accordingly, embodiments may be constructed in which acts are performed in an order different than illustrated, which may include performing some acts simultaneously, even though shown as sequential acts in illustrative embodiments.

All definitions, as defined and used herein, should be understood to control over dictionary definitions, definitions in documents incorporated by reference, and/or ordinary meanings of the defined terms.

The indefinite articles “a” and “an,” as used herein in the specification and in the claims, unless clearly indicated to the contrary, should be understood to mean “at least one.”

The phrase “and/or,” as used herein in the specification and in the claims, should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements may optionally be present other than the elements specifically identified by the “and/or” clause, whether related or unrelated to those elements specifically identified. Thus, as a non-limiting example, a reference to “A and/or B”, when used in conjunction with open-ended language such as “comprising” can refer, in one embodiment, to A only (optionally including elements other than B); in another embodiment, to B only (optionally including elements other than A); in yet another embodiment, to both A and B (optionally including other elements); etc.

As used herein in the specification and in the claims, “or” should be understood to have the same meaning as “and/or” as defined above. For example, when separating items in a list, “or” or “and/or” shall be interpreted as being inclusive, i.e., the inclusion of at least one, but also including more than one, of a number or list of elements, and, optionally, additional unlisted items. Only terms clearly indicated to the contrary, such as “only one of” or “exactly one of,” or, when used in the claims, “consisting of,” will refer to the inclusion of exactly one element of a number or list of elements. In general, the term “or” as used herein shall only be interpreted as indicating exclusive alternatives (i.e. “one or the other but not both”) when preceded by terms of exclusivity, such as “either,” “one of,” “only one of,” or “exactly one of” “Consisting essentially of,” when used in the claims, shall have its ordinary meaning as used in the field of patent law.

As used herein in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B,” or, equivalently “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements); etc.

In the claims, as well as in the specification above, all transitional phrases such as “comprising,” “including,” “carrying,” “having,” “containing,” “involving,” “holding,” “composed of,” and the like are to be understood to be open-ended, i.e., to mean including but not limited to. Only the transitional phrases “consisting of” and “consisting essentially of” shall be closed or semi-closed transitional phrases, respectively, as set forth in the United States Patent Office Manual of Patent Examining Procedures, Section 2111.03.

1. A computer-facilitated method for logging an electronic record of a locate operation to locate a presence or an absence of at least one underground facility, the method comprising:
automatically processing, by at least one processor, marking data representative of a locate operation so as to determine at least one symbol associated with the locate operation, the symbol represented by symbol data; and
storing the marking data and the symbol data in at least one memory to form an electronic record of the locate operation.

2. The method of claim 1, wherein automatically processing comprises determining the at least one symbol based at least in part on the marking data.

3. The method of claim 2, wherein automatically processing comprises determining the at least one symbol from marking data representative of one or more of marking material color, length of marks, facility type and geographic coordinates of marks.

4. The method of claim 1, wherein automatically processing comprises determining the at least one symbol based at least in part on a locate operation work order that corresponds to the locate operation.

5. The method of claim 1, wherein automatically processing comprises determining the at least one symbol based on the marking data and a locate operation work order that corresponds to the locate operation.

6. The method of claim 1, wherein automatically determining comprises determining a symbol based at least in part on governmental regulations with respect to underground facility locate operations.

7. The method of claim 1, wherein automatically processing comprises determining a number of symbols and/or a spacing between symbols based at least in part on governmental regulations with respect to underground facility locate operations.

8. The method of claim 1, wherein automatically processing comprises determining a symbol representative of a facility owner.

9. The method of claim 1, wherein automatically processing comprises determining a symbol representative of a facility type.

10. The method of claim 1, wherein automatically processing comprises determining a symbol representative of two or more facilities in a conduit or in a common trench.

11. The method of claim 1, wherein the symbols include one or more alphanumeric characters.

12. The method of claim 1, wherein the symbols include one or more geometric symbols.

13. The method of claim 1, further comprising generating a graphical representation of the locate operation, the graphical representation based on the marking data and including the at least one symbol.

14. The method of claim 1, wherein the locate equipment comprises a marking device.

15. The method of claim 1, wherein the locate equipment comprises a combination locate and marking device.

16. The method of claim 1, wherein automatically processing is performed at the locate equipment.

17. The method of claim 1, further comprising transmitting the marking data from the locate equipment to a remote computing device, wherein automatically processing is performed at the remote computing device.

18. The method of claim 1, wherein automatically processing includes determining a symbol type from a locate operation work order and determining a symbol location from the marking data.

19. The method of claim 1, wherein automatically processing includes determining geographic coordinates at which the at least one symbol is displayed on the graphical representation of the locate operation.

20. A system for logging an electronic record of a locate operation to locate a presence or an absence of underground facilities, the system comprising:
locate equipment configured to perform at least part of the locate operation and to acquire marking data representative of the locate operation; and
a computing device distinct from the locate equipment, the computing device configured to receive the marking data from the locate equipment, and to store the marking data and symbol data to form an electronic record of the locate operation, the symbol data, representative of at least one symbol, being automatically determined by the locate equipment or the computing device.

21. Locate equipment for performing a locate operation to locate a presence or an absence of underground facilities, the locate equipment comprising:
a marking material dispensing system configured to dispense marking material during the locate operation;
a data acquisition module configured to acquire marking data representative of the locate operation;
a symbol insertion module configured to automatically determine at least one symbol associated with the locate operation, the symbol represented by symbol data; and
a memory configured to store the marking data and the associated symbol data to form an electronic record of the locate operation.
